(19) United States
(12) Patent Application Publication
(10) Pub. No.: US 2004/0230471 A1
(43) Pub. Date: Nov. 18, 2004

(54) Business intelligence system and method

(76) Inventor: Cyril Henry Putnam Brookes, Castlecrag (AU)

Correspondence Address: PEARNE & GORDON LLP, 1801 EAST 9TH STREET, SUITE 1200, CLEVELAND, OH, 44114-3108, US

(21) Appl. No.: 10/782,312

(22) Filed: Feb. 19, 2004

(30) Foreign Application Priority Data
Feb. 20, 2003 (AU) 2003900776

(51) Int. Cl. G06F 17/60

(52) U.S. Cl. 705/10

(57) ABSTRACT

A Business Intelligence requirements specification system for utilisation in conjunction with the operations of an organisation, the specification system including: at least one of four independent interactive modules supporting interrogation of, or self-analysis by, an executive, each of the modules eliciting and storing information requirements relevant to the organisation, the modules including: (a) a first module eliciting and storing information requirements related to the operational status of the organisation; (b) a second module eliciting and storing information requirements about the relevant acceptability of the operational status of the organisation; (c) a third module eliciting and storing information requirements derived from forecasting and exception analysis models of the organisation; and (d) a fourth module eliciting and storing information and model requirements likely to be required should a problem be identified with the organisation. The system also being effective in auditing and reporting on the quality and adequacy of existing Business Intelligence systems.

### FIELD OF THE INVENTION

The presenting invention relates to the field of information management reporting systems and, in particular, discloses a system for the specification of executive information reporting requirements for Business Intelligence systems in a corporate environment. The invention also supports the auditing and reviewing of existing business intelligence system environments, identifying the areas that will benefit most from new or revised systems.

### BACKGROUND OF THE INVENTION

Traditionally, the (EIS) Executive Information Systems and (BI) Business Intelligence software market originated with products released progressively from 1975 onwards. The first such products were financial planning based. Spreadsheets became very popular from the 1980s and these applications made the provision of both raw data and processed information more available. Transactions processing systems, for applications such as inventory management, order processing, costing, etc. became widely available in corporations, creating new databases as a by-product. Systems to report from the new data resources then made their first appearance. IBM's Structured Query Language (SQL) and Query by Example (QBE) retrieval packages were new approaches to retrieval.

Comshare's Commander EIS and Pilot Software's Lightship were two of the first applications specifically oriented to the EIS market, merging the capabilities of data access, data manipulation, report preparation and query processing.

By 1990, a large market for financial database applications had evolved, e.g. Oracle that included general purpose General Ledger systems. At about the same time Enterprise Resource Planning (ERP) packages such as SAP and Peoplesoft became a dominant force in corporate computing. ERP systems create a huge data repository which, when added to that available from other financial and transaction applications, required a new approach to information access procedures.

From the 1990s, technology of modelling and data mining developed at a high rate. Systems capable of analysing huge databases, such as those created by ERP packages were developed. Financial modelling to forecast cash flow and quantify “what-if” analyses were perfected. Statistical analysis packages from SAS and SPSS became widely used for intelligent data retrieval and analysis.

The Internet and the merging of the importance of text data with numeric data has recently spawned the growth of the Corporate Portal, offering the same service for the corporation as Yahoo! does for the personal users of the web. These developments created new types of executive and management reporting, now often described under the generic terms Knowledge Management or Business Intelligence systems as well as the term EIS used in this invention description.

All these developments greatly increased the reporting and retrieval capabilities, so much so that the ability to specify what executives wanted, or needed, out of all the available data became hard to specify. Indeed, executives are today often faced with an overload of information that actually reduces their overall productivity.

The accumulation of new demands and opportunities has led to rapid growth of the Knowledge Management (KM) and Business Intelligence (BI) sectors of the IT software market.

It is apparent from the above discussion that there is already a large number of EIS (including KM and BI) applications. Further, the high volumes of sales of Query/Retrieval/Reporting software means that many such systems are being implemented now and even larger numbers will be planned in the future. All these systems often involve the application of software tools to a variety of databases using different display formats, statistical calculations and retrieval technology.

It is axiomatic to state that:

Before implementation of any information access and reporting system, the data/information to be displayed, its format and the frequency of reporting must be specified by the executive(s) who will use the system.

However this specification task is both difficult and usually poorly executed. The highly regarded text book “Building Executive Information Systems” by Watson, Houdeshel and Rainer, summarises this situation as:

Because executives perform highly unstructured work, it is difficult to identify their information requirements.

What information to include in an EIS is critical. If the users do not find the system's contents to be helpful in performing their job responsibilities, they have no reason to use it. The challenge is in finding what information to include. Getting executives to specify what information they want is the primary worry of EIS developers.

The different approaches adopted by EIS developers can be summarised in the Table below. Some techniques are duplicated if they can be adopted in more than one way.

| | Non-Computer Related | Computer Related |
|---|---|---|
| Direct | Discussions with executives | Examinations of computer |
| Executive | EIS planning meetings | generated information |
| Interaction | Volunteered information | Examinations of other |
| | Examinations of non-computer | organizations' EIS |
| | generated information | |
| | Critical success factor sessions | |
| | Participation in strategic | |
| | planning sessions | |
| | Strategic business objectives | |
| | method | |
| | Tracking executive activity | |
| Indirect | EIS planning meetings | Examinations of computer |
| Executive | Discussions with support | generated information |
| Interaction | personnel | Examinations of other |
| | Examinations of non-computer | organizations' EIS |
| | generated information | Software tracking of EIS |
| | Attendance at meetings | usage |
| | Examination of the strategic | |
| | plan | |
| | Tracking executive activity | |

The “Discussion with Executives” approach is critical to the system's success. However, it is not simple to apply. From the aforementioned text:

Simply asking the executive what information is wanted rarely results in a comprehensive description of information needs. Answers will be influenced by what information the executive has seen recently, the contents of existing reports, current problems and the executives limited understanding of what can be done with information technology.

Some analysts are able to get little or no time, while others have good access to the firm's executives . . . noting that the amount of time an analyst gets is often related to how well the analyst knows the business.

One of the most widely practiced approaches to the implementation of EIS systems is the Balanced Scorecard developed by Kaplan and Norton. Their concept focuses on ensuring that executives and EIS designers adopt a “balanced” approach to the implementation of systems. They state that executive reporting systems should have four reporting component perspectives Robert Kaplan and David Norton. The Balanced Scorecard—Measures that Drive Performance. HBR Jan-February 1992:

Customer

Internal business

Innovation and learning

Financial

The various approaches listed in the earlier table are all operationally possible. However, they suffer from the following deficiencies. Specifically, they:

Overlap, and the resultant specifications require substantial culling, to remove duplicate items.

Require skilled, experienced, consultants

Do not easily allow for the experience in earlier projects to be communicated or used by executives and consultants in later ones

Contain a mix of information required for “routine” regular reporting with that needed to solve problems that rarely arise—requiring further analyses/interviews

Are often confusing and frustrating for executives, who see them as inefficient and unproductive

Although the four information reporting perspective categories of Kaplan and Norton are useful in defining segments of an EIS requirements study, they remain broad concepts. The analysis techniques required to determine specific measures required by executives are still the same as described in Table 1. This process is described in a later paper by Kaplan and Norton Kaplan and David Norton. Putting the Balanced Scorecard to Work. HBR September-October 1993 p 128.

### SUMMARY OF THE INVENTION

It is an object of the present invention to provide for an improved Business Intelligence or Executive Information Reporting System through a more accurate and complete system requirements specification. A second objective is to improve the facilitation of the auditing of existing Business Intelligence systems to identify areas where current systems are inadequate or missing valuable components.

In accordance with a first aspect of the present invention, there is provided an executive information requirements specification system for utilisation in conjunction with the operations of an organisation, the system including: at least one of four independent interactive modules for interrogation of, or self-analysis by, an executive, each of the modules eliciting and storing information requirements relevant to the organisation, the modules including: (a) a first module eliciting and storing information requirements related to the operational status and Key Performance Indicators (KPIs) of the organisation; (b) a second module eliciting and storing information requirements about the relevant acceptability of the operational status and KPIs of the organisation; (c) a third module eliciting and storing information requirements derived from forecasting and exception analysis models of the organisation; and (d) a fourth module eliciting and storing information and model requirements likely to be required should a problem be identified with the organisation.

Each of the modules preferably can include a number of sub-modules eliciting and storing information requirements relevant to the module for interaction by a user. The first module preferably can include a series of submodules directed to at least one of organisation key performance indicators and customer feedback. The second module preferably can include a series of submodules directed to at least one of many possible benchmarks that the organisation has sought to achieve, relative performance measurements and market feedback. The third module preferably can include a series of submodules directed to significant changes in at least one of trends established in operational key time series, the validity of model assumptions made in forecasting and unexpected events in the marketplace. The fourth module preferably can include a series of submodules directed to at least one of tools allowing for fast diagnosis of problems and to ensuring data availability for answering anticipated questions.

The system can be implemented via an internet browser environment or for a stand-alone or network of personal computers.

In accordance with a further aspect of the present invention, there is provided a method of providing executive information in a useable form the method comprising the step of providing an interactive computer based system including a series of interactive modules, the modules including: (a) a first module eliciting and storing information requirements related to a operational status and KPIs of the organisation; (b) a second module eliciting and storing information requirements about the relevant acceptability of the operational status and KPIs of the organisation; (c) a third module eliciting and storing information requirements derived from forecasting and exception analysis models of the organisation; and (d) a fourth module eliciting and storing information and model requirements likely to be required should a problem be identified with the organisation.

### BRIEF DESCRIPTION OF THE DRAWINGS

Preferred embodiments of the present invention will now be described with reference to the accompanying drawings in which:

FIG. 1 illustrates schematically the operational environment of the preferred embodiment;

FIG. 2 illustrates an initial flow chart of the operation of the preferred embodiment;

FIG. 3 illustrates a flow chart of the structure of a typical channel;

FIG. 4 illustrates a flow chart of the module reporting operation;

FIG. 5 illustrates a flow chart of the administrative functions of the preferred embodiment;

FIG. 6 to FIG. 13 illustrates a series of screen shots of one form of implementation of the invention; and

FIG. 14 to FIG. 16 illustrates a second form of implementation of the invention

### DESCRIPTION OF PREFERRED AND OTHER EMBODIMENTS

The preferred embodiment, hereinafter referred to as “BI Pathfinder” implements an information Query/Retrieval/Reporting system design specification methodology. The methodology also relates to the specification of Knowledge Management and Business Intelligence reporting systems. It is designed to be used by IT consultants who act as facilitators to executives in the initial phase of an EIS, KM or BI system. It assists in this process by:

Providing a structured approach to the requirements specification task,

Building confidence in both the client executive and the facilitator that the process is productive and is focused on the relevant industry or business context

Automatically compiling a specification report that covers the complete decision making process

The specification report can be used by consultant to build the enhanced EIS system as chosen by the executive(s).

Key features of the Pathfinder approach to EIS specification include:

Using a specially constructed (for the appropriate industry) EIS measure set, comprising potentially useful data reporting suggestions for the resultant system that are relevant

Offering examples of reporting similar to the suggested measures, so the executive is able to assess the benefit, or otherwise, of receiving such reports

Providing the opportunity to re-examine any aspect of the specification task, automatically updating the Pathfinder report

The Pathfinder methodology is customised for each industry that is addressed by its client executives and facilitators. The customisation is achieved by adapting the suggested EIS measures (or the questions) proposed to the executive as the requirements specification process evolves.

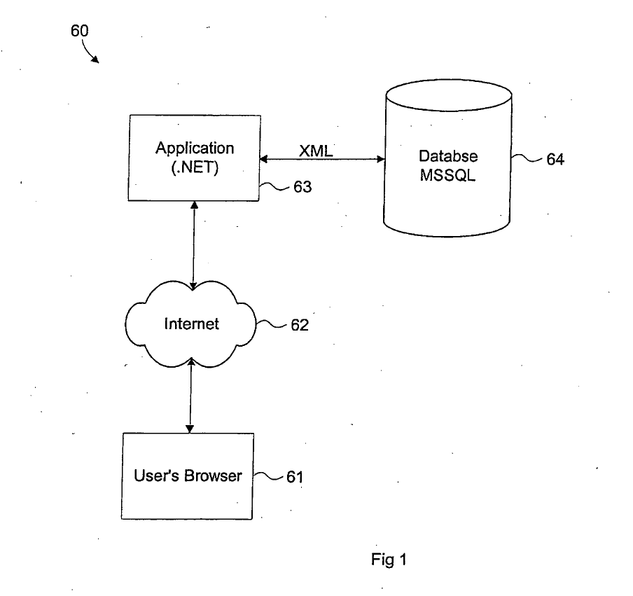

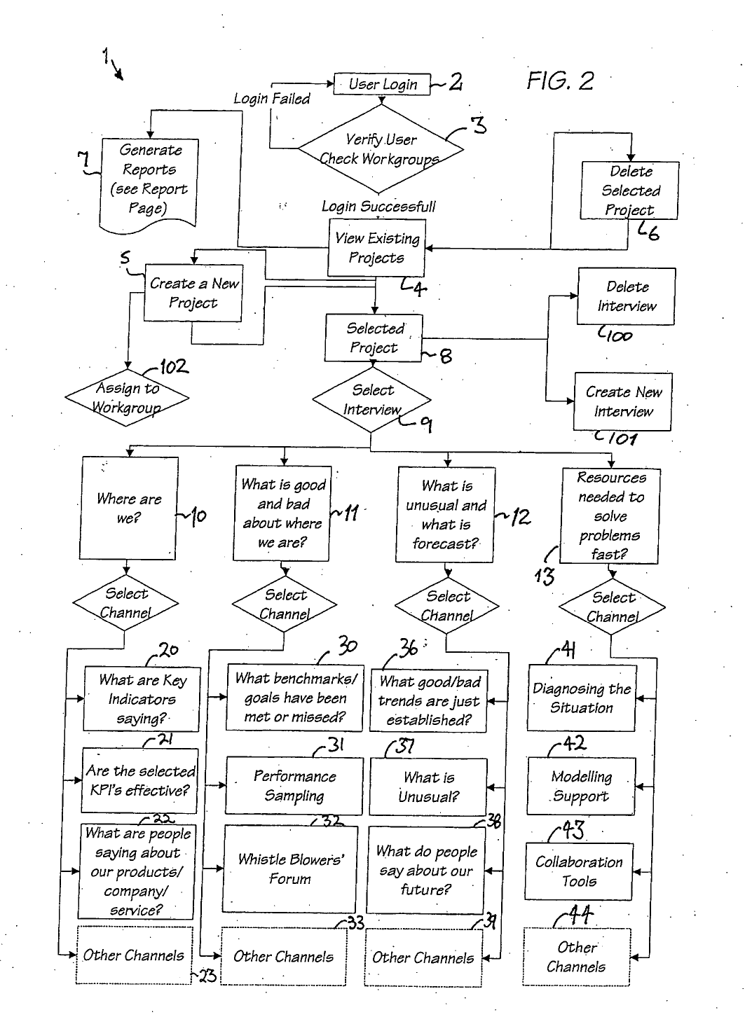

In a first embodiment, the foregoing principles are implemented by providing an Internet browser based system for providing executive information management. Whilst many different forms of implementation are possible, including stand alone computer software, a first embodiment is designed to be implemented in an Internet environment such as that depicted 60 in FIG. 1 and includes a user's browser 61 which can be Microsoft Internet Explorer or the like. The browser interacts over the Internet 62 with an application server 63 which in turn stores information on an internal database 64. The application architecture can be multitiered including a Data Tier, Business Logic Tier and a Presentation Tier. The preferred embodiment can be constructed using the standard MICROSOFT .NET, MS SQL AND XML software. An alternative using J2EE and other web server and database software would achieve the same result. This allows for continued extendibility and customisation of operations. The software design of the system is illustrated by the flowchart 1 of FIG. 2 wherein a user logs into the system 2 and is verified 3. Upon a successful login, a series of existing projects for selection are presented to the user 4. Typically a user is a consultant or other facilitator who is interviewing one or more executives to determine the BI or EIS system requirements for a project. Alternatively, the user may be auditing the adequacy of existing BI systems. There may be one or many interviews as part of a project. Various updating facilities are available for each project and its related interviews. These include the ability to create 5 and delete 6 projects. New projects can be assigned to nominated workgroups 102. Also provided is the facility to view reports in respect of projects 7.

A facility to select a specific project is also provided 8. Having selected a project 8 an interview record can be deleted 100. More commonly the user can create a new project interview 101, supplying relevant information including the interview type (for example: a standard interview, a group interview, an assessment of earlier interviews), the identity of the interviewee and the date. One interview is selected for further processing 9. For each project interview, four separate interactive modules are available including modules 10, 11, 12, 13. Each of the modules 10-13 includes a further series of channels. For example, the module 10 includes channels 20-22. Other channels e.g. 23 can be added in accordance with requirements.

Further, module 11 includes channels 30-33. The module 12 includes channel 36-39 and the module 13 includes the channels 41-44. Each of the modules provides for a series of interactions with the facilitator and executive utilising the system The executive is invited to interact with each of the modules in turn to complete the specification or audit of the BI system.

A major benefit of BI Pathfinder is that it proposes a set of small questions for consideration by the executive and facilitator that are substantially independent of one another. As a result, the Pathfinder BI specification contains requests for information and data analysis that are cumulative. Therefore, the answer to the big question “What information do you want?” that is the objective of a BI system specification process is the logical sum of the answers to the independent smaller questions contained in the channels.

The decomposition process for the big question involves a number of levels, each one involving narrower concepts than its parent. The first level is implemented by the modules 10-13. The overall BI system specification is seen to be the sum of the responses from the four independent modules:

Where are we? (10)

What is good and bad about where we are? (11)

What is unusual and what is forecast? (12)

What resources do we need to help solve problems fast? (13)

Each of these specification modules e.g. 10 has a number of support channels associated with it e.g. 20-23. Each support channel contains a set of suggested BI measures performance indicators, grouped within nominated business process areas. Each BI measure is a data item that may be a valuable information resource for the executive.

The support channels also contain examples of typical reports and formats (appropriate for the relevant industry) that assist the executive and facilitator in determining the value of each suggestion.

Further information is provided on each module as follows:

Module 1: “Where Are We?” (10)

“Where are we?” is the first module offered by Pathfinder. It's objectives for the executive can be summarized as ensuring a satisfactory answer to the following:

What are the Key Indicators saying about our finances, industry, customers, operations and corporate health? (20)

Are the Key Indicators effective? Provide an audit of Key Indicators showing they are what I need to make good decisions (21)

What are people saying about our products, our service, our company, our industry? (22)

Module 2: “What is Good and Bad with Where We Are?” (11)

This second module of the BI or EIS system specification focuses on supporting the assessment of the status information that is delivered from the “Where are we?” reports. It aims to give satisfactory answers to the issues:

What benchmarks/goals or targets have we met or missed? (30)

What Performance Sampling can identify exceptions that are examples of particularly good or bad performance? (31)

What are the “Whistle Blowers” saying about our performance? (32)

Module 3: “What is Unusual and What is Forecast? ” (12)

The capability of modern EIS and BI systems extends well beyond the reporting of data and information. Determining likely future values of Key Indicators is now a regular feature of periodic reporting and ad-hoc queries. Similarly, the analysis of detailed databases, seeking trends and unusual changes in behaviour, etc. is now relatively simple, given the right tools. This module therefore gives answers to:

What good/bad trends are just established in key performance areas? (36)

What is unusual or surprising about current or future operations? (37)

What do people say about our future? (38)

Module 4: “What Resources do we Need to Help Solve Problems Fast? (13)

One of the critical distinctions that needs to be made in building an EIS specification is to separate the information needed for routine purposes, the “dashboard” of Key Indicators (say), and that information required to solve problems that do not yet exist. The first three modules of Pathfinder (10-12) are directed at establishing the status quo, and to determine if any problems exist that need a response. The fourth module is intended to support rapid information access and retrieval when a problem is identified and action may be required.

Of course, only a few potential problem situations can be forecast. Often, however, it is desirable to have the query, reporting and forecasting model capabilities ready—to expedite diagnosis and solution. The module is directed to answering the following:

Fast diagnosis/solution of problems needs ad-hoc customized tools for drill-down (41)

What planning models are required for rapid diagnosis of problems? (42)

What collaboration support tools are desirable? (43)

As noted previously, each module of Pathfinder has a further level of decomposition contained in each channnel. It presents to the executive and facilitator a set of BI measures for consideration during the interview and possible inclusion in the Pathfinder interview reports. Examples of sample reports are able to be associated with one or several measures.

The channel content can be specific to a particular project, industry or enterprise and customised on an ongoing basis. A generic channel set is used as the basis for all the individual industry channel BI measure sets. The channels for each measure are shown in the Table below.

| | | | What resources do |
|---|---|---|---|
| | What is good and | What is unusual | we need to help |
| | bad with where we | and what is | solve problems |
| Where are we? | are? | forecast | fast? |
| Key Indicator | Performance against | Forecasting Models - | Diagnosing the Situation - |
| Summaries - Telling | Benchmarks - relating | Presenting future | Finding the right data |
| you about the | the status to “par”, or | estimates with | resources, “drilling-down”, |
| important numbers | earlier achievements | comparison against | finding any related |
| | | benchmarks | situations and data |
| Sample Audit - Drill | Performance Sampling - | What is Unusual? - | Modelling Support - |
| down for items | finding good and bad | finding what is different | Building potentially useful |
| selected or randomly | among the dross | that may be early | models in advance of |
| chosen | | warning of problems or | problem occurrences |
| | | opportunities | |
| The People Factor - | Whistle Blowers Forum - | Forecasters Forum - | Collaboration - Finding |
| What are they saying | the “suggestion box”? | What the subject experts | the “expert” and sharing |
| about our status and | | are saying about the | experiences |
| performance? | | trends and unusual | |
| | | events | |

The BI measures associated with a channel are subdivided into business process categories. This allows related BI measures, for example those associated with Procurement, to be considered together. Typically the set of business processes used in BI Pathfinder may include the following (but other business process categories may be nominated and used if required) Management and Infrastructure, Procurement, Technology Development and Service, Human Resources and Corporate Health, Marketing, Inbound Logistics, Operations, Outbound Logistics, Service.

For some channels, a business process category may not have any associated BI measures.

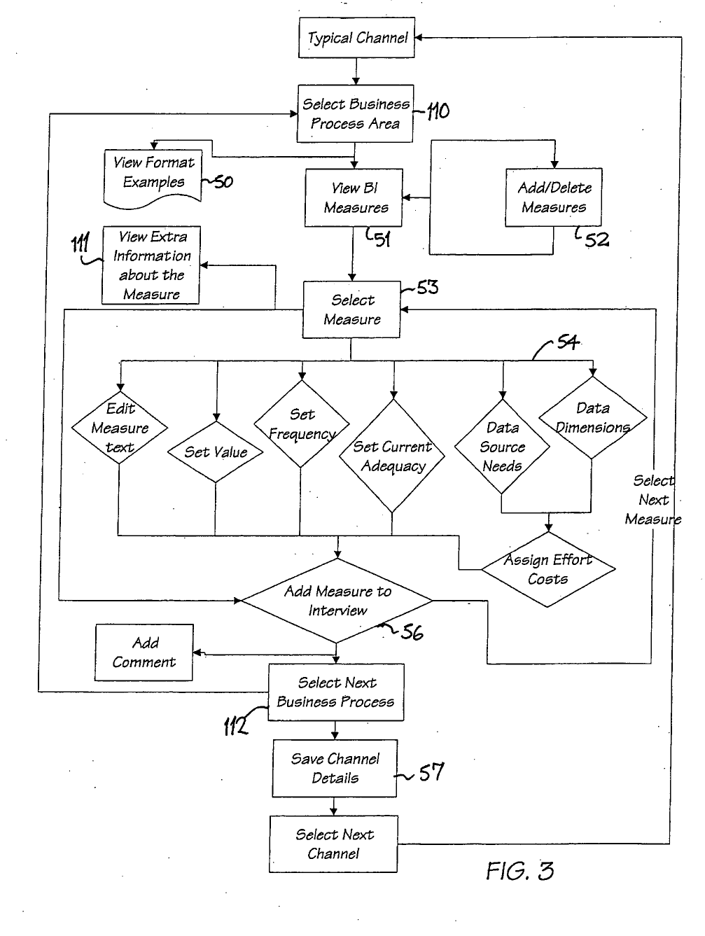

The operations available at each channel are illustrated in FIG. 3. For each channel, a series of reporting examples are provided 50. For each project a number of business process areas are nominated. The user selects a business process and its associated measures 110. The user is able to view the BI measures 51 and add or remove measures 52. Each measure the executive believes is a useful data item for reporting will be selected by the user 53. Extra information about the measure can be displayed 111. For the selected measure 53, it is possible to perform various operations including: edit the description, nominate the measure's value (that is the importance this measure has for the BI system), assess the adequacy of a current implementation for this measure and to propose other parameters such as required security, frequency of reporting, data sources, data dimensions and so on 54. These parameters and values can then be added to the overall project interview record 56. Other business process can be selected and the relevant measures considered in turn 112. When the relevant business processes and measures have been considered the channel data is saved in the project interview record 57.

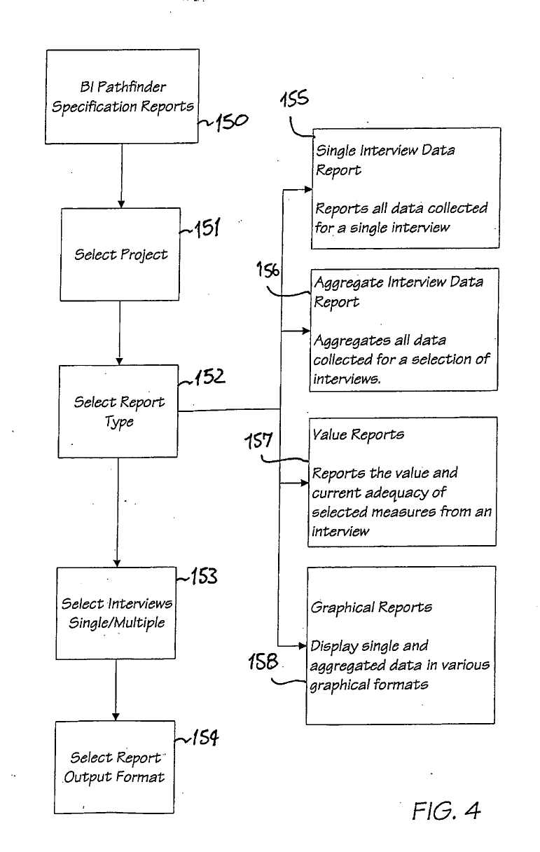

The BI Pathfinder system is able to produce several standard reports 150 as illustrated in FIG. 4 with the report information being drawn from the project interview databases. A project is selected from those available 151. A report type is selected 152, and then the interviews to be reported 153 and the format 154. These reports 155 156 157 158 are intended to assist executives and consultants assess the adequacy of the interview process and to facilitate the implementation of the system by information technology specialists. In particular, the implementation support includes the relationship between BI measures and underlying data requirements. The process of Auditing an existing BI reporting context is specially assisted by the reports 157 158 that link the value of BI measures to interviewees and the adequacy of current implementations of BI systems to report those measures.

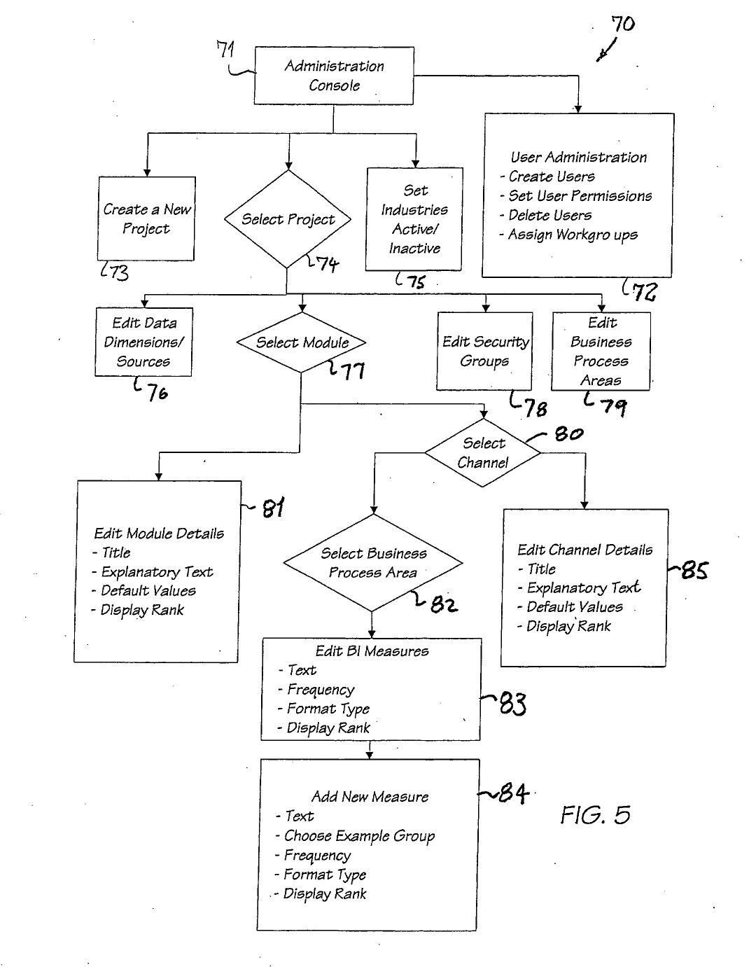

Further, the system includes the usual administrative functionality. This applicable flow chart is provided in FIG. 5. The administrative functions can be accessed by an administration console 71. The console can provide the ability to perform the usual user administration tasks 72. Also the ability to provide for new project creation can be provided 73 and various industry information can be provided 75.

Each project can be selected 74 and various editing functions performed 76, 77, 79. Within each project the various modules can be selected 77 and the module details edited 81. Further, within each module, each channel can be selected 80 and either the channel details edited 85, or a business process area of a channel selected 81 and the details edited 83 or new measures added 84.

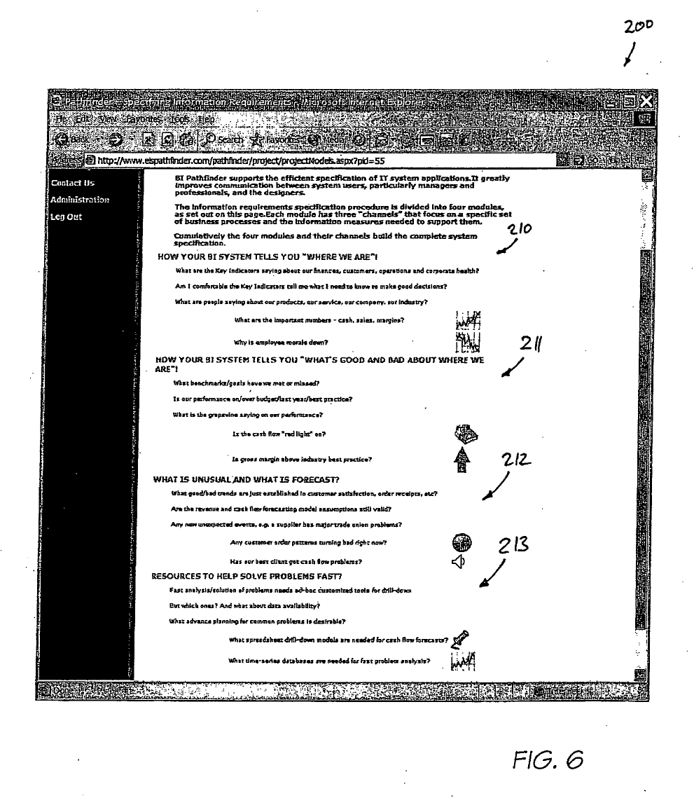

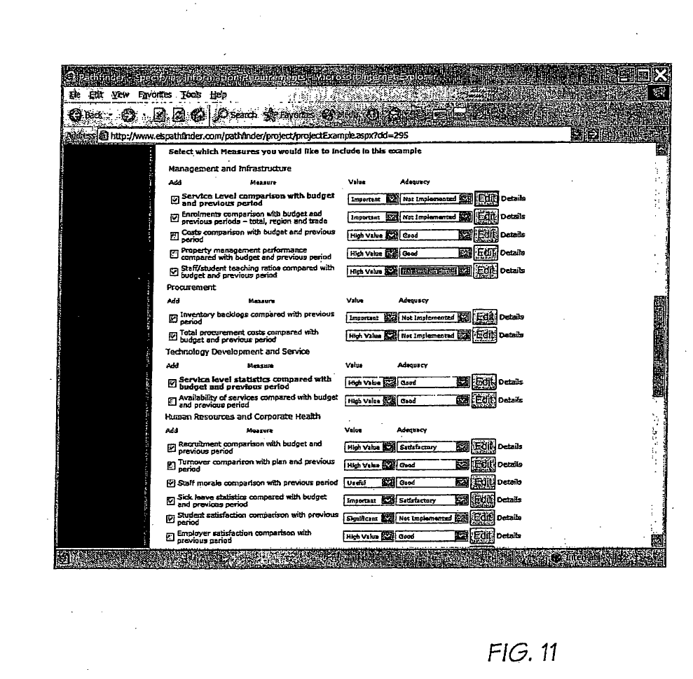

FIG. 6 to FIG. 13 show one form of screen layout of implementation of the flowcharts. Obviously different screen layouts collecting similar information obtained during an interview would be necessary if the implementation was based on different software.

In FIG. 6, there is shown an example of the Module Text screen 200 which is the pivot point that allows the user to select the required module from Modules 210, 211, 212, 213

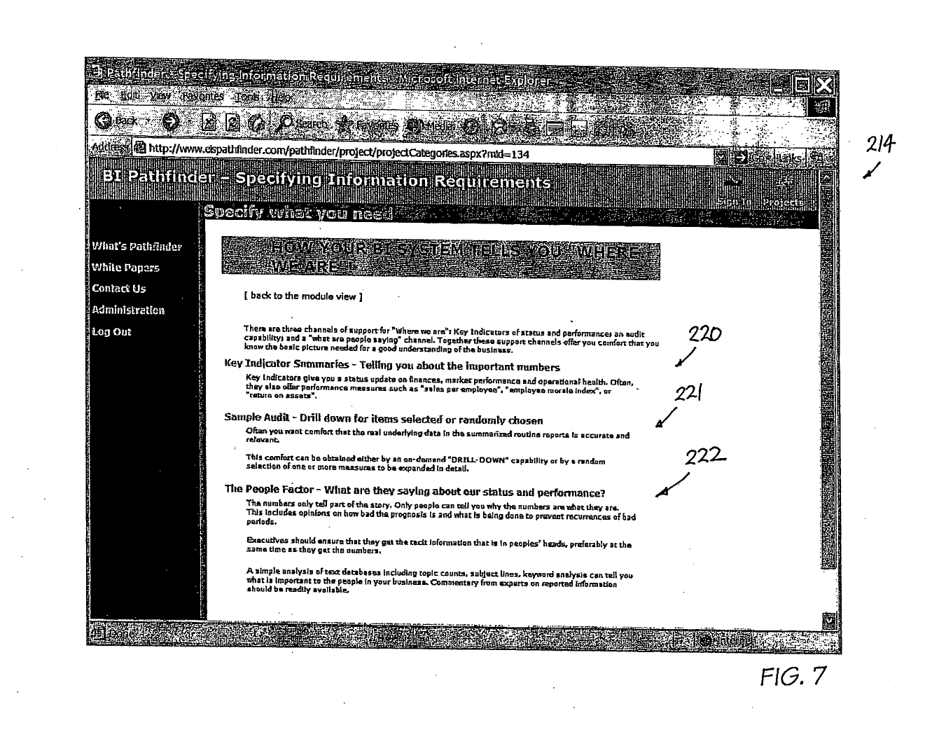

FIG. 7 illustrates the channel text screen 214 which allows the user to select the appropriate channel, 220, 221, 222 for Module 10. Similar screens would be created for the other modules.

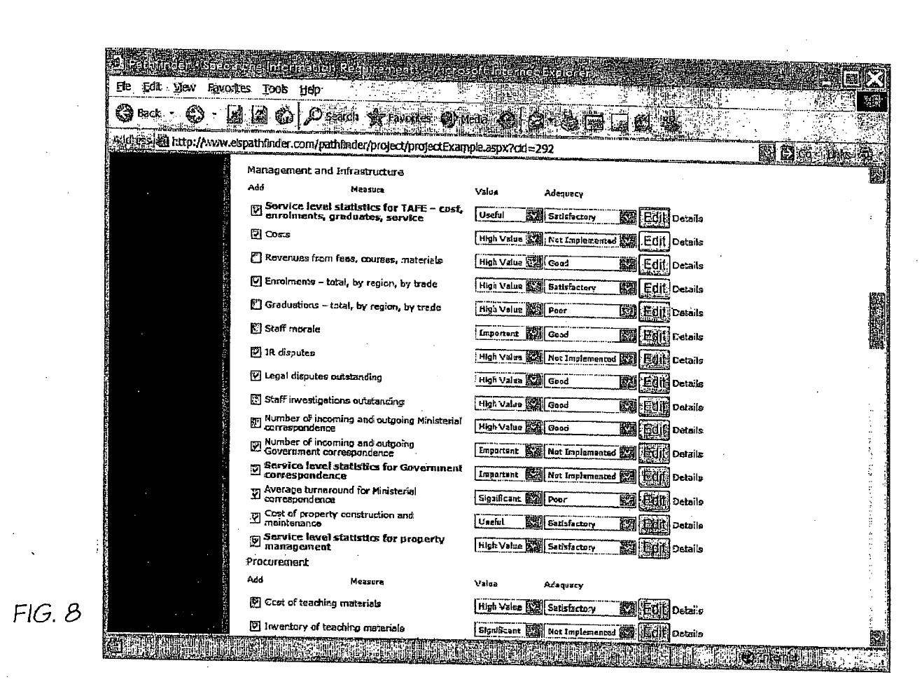

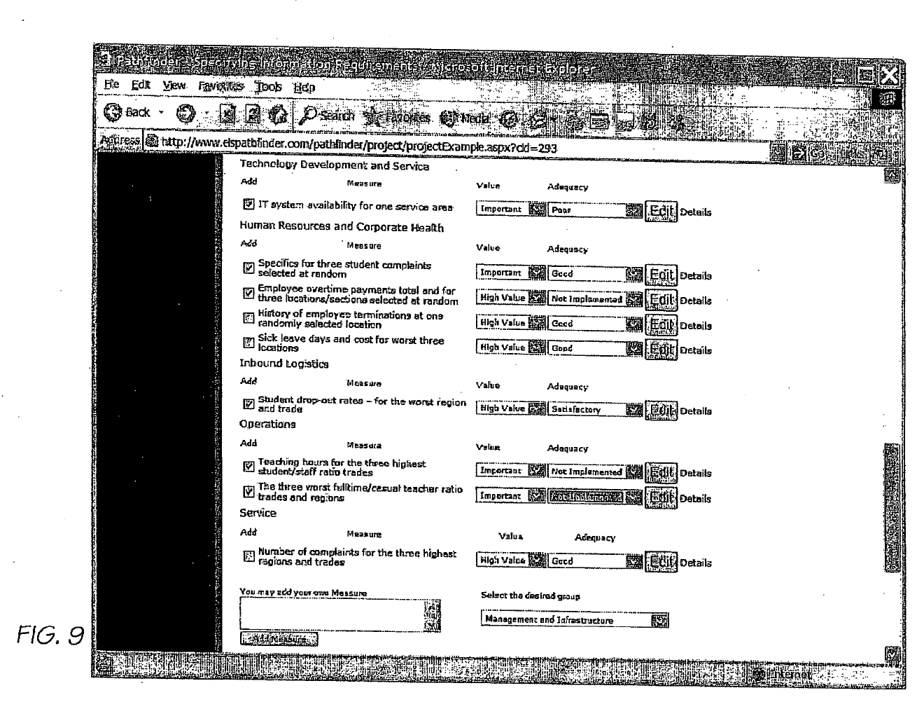

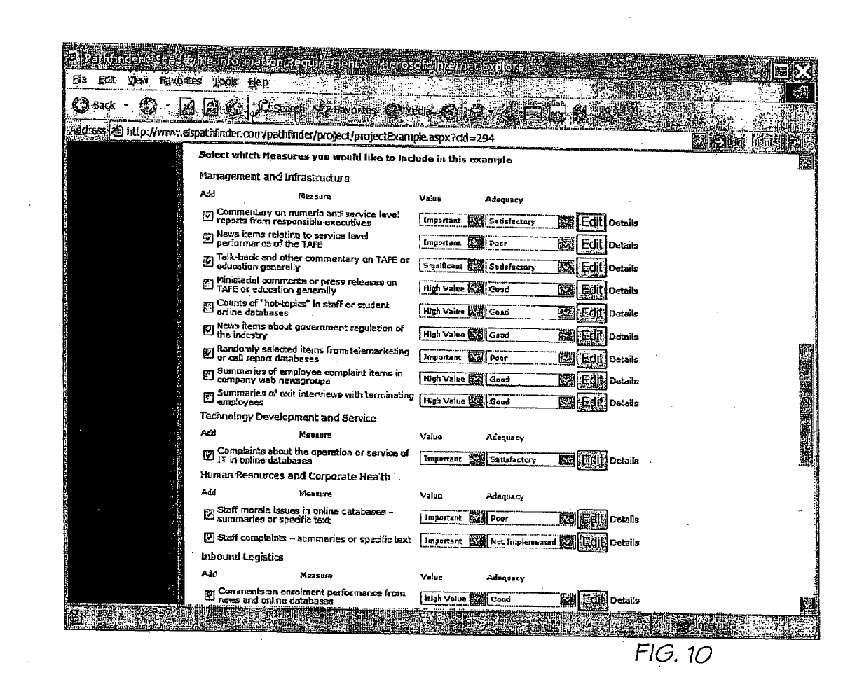

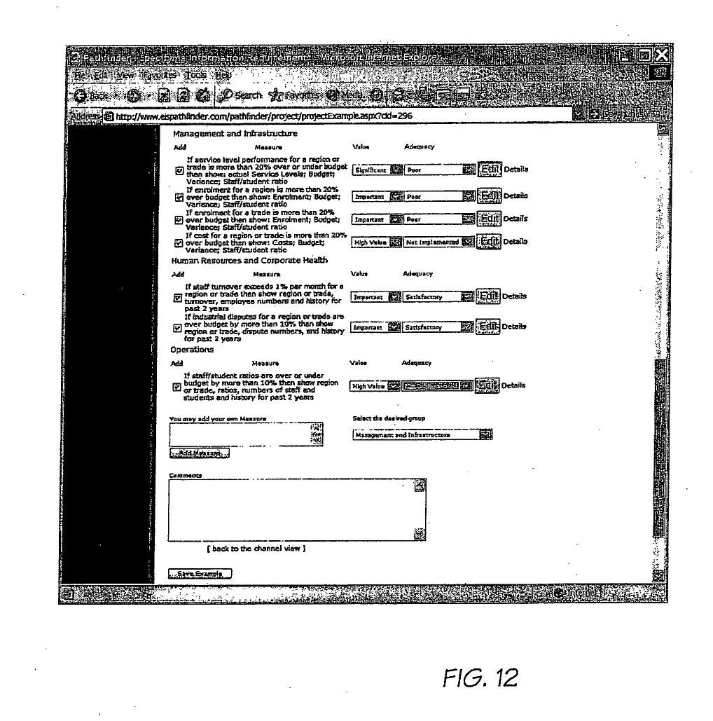

FIG. 8 illustrates how the channel 20 is implemented with the user accessing a number of subject areas and providing value and adequacy indicators. FIG. 9 illustrates one form of how the channel 21 is implemented. FIG. 10 shows one form of how the channel 22 is implemented and FIG. 1I illustrates how the channel 31 is implemented and FIG. 12 shows one form of implementation of the channel 32. The other channels can be implemented in a similar manner.

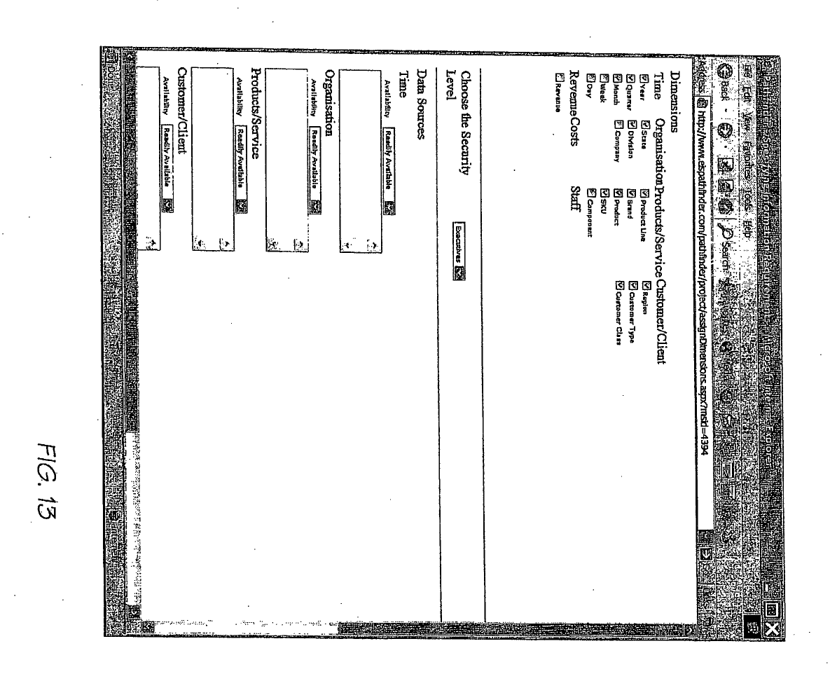

FIG. 13 illustrates a details entry screen which shows how additional attributes associated with each measure specification, for example frequency, format, data sources are collected. Each channel screen can give access to a similar Details screen.

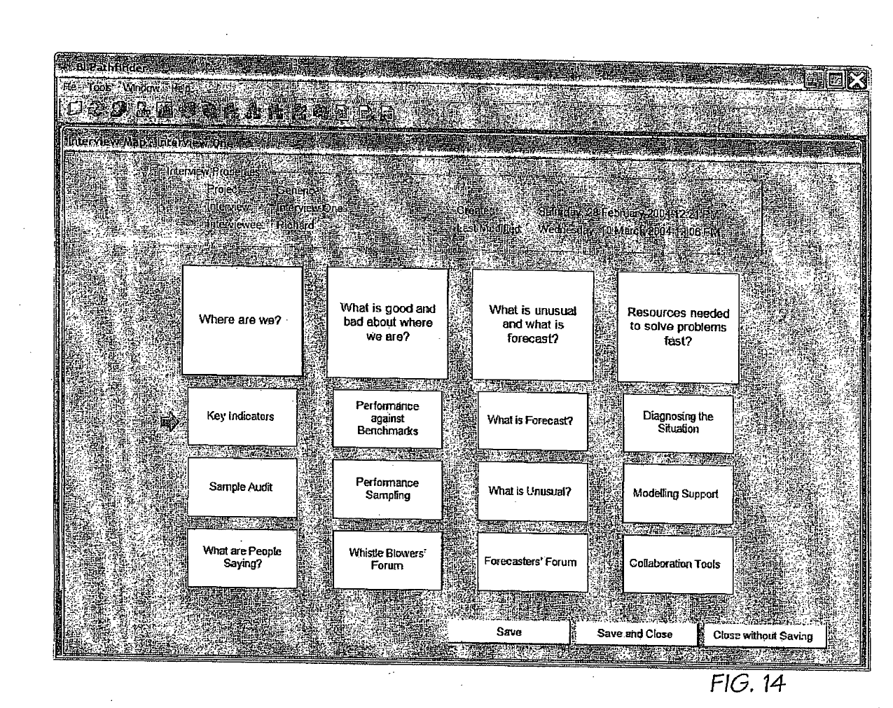

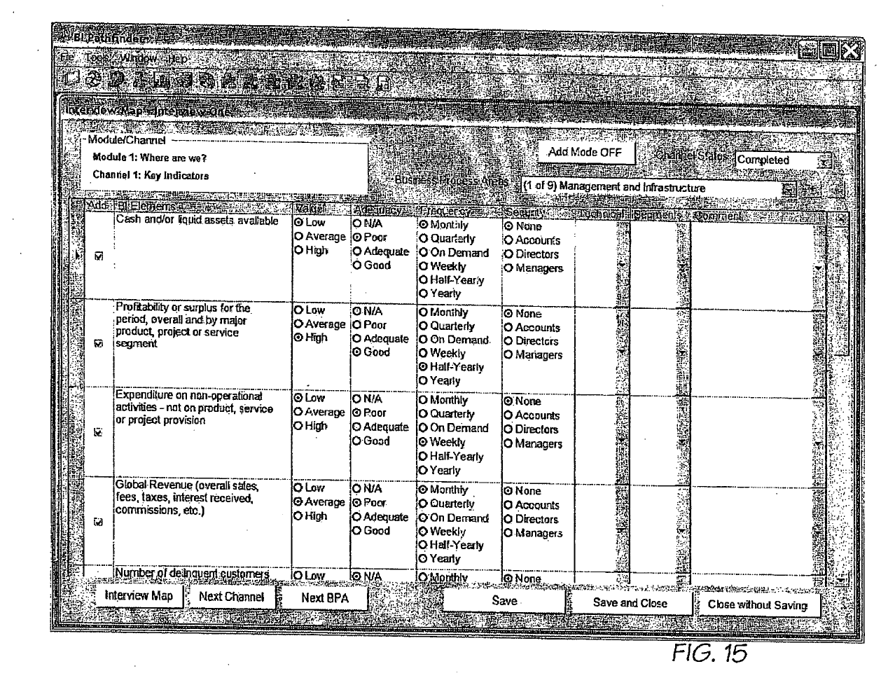

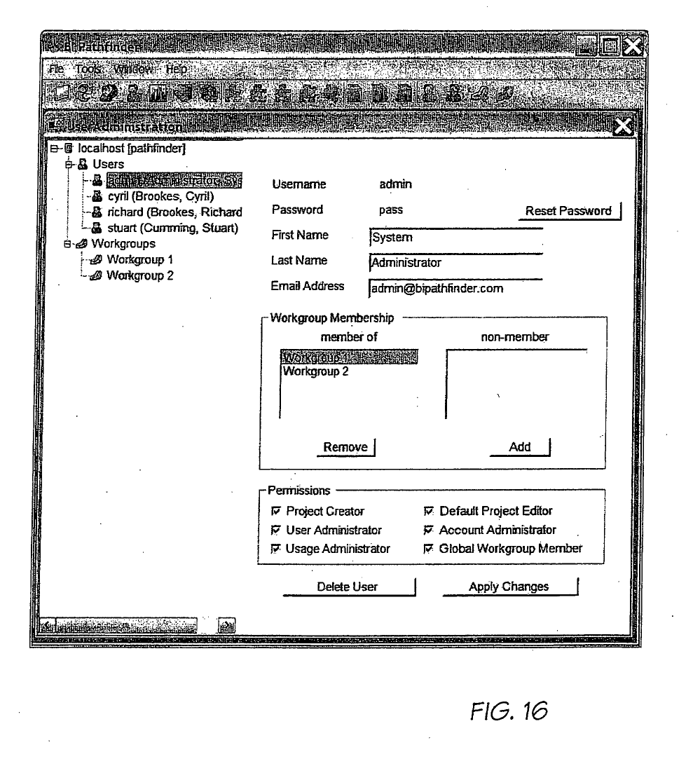

Other forms of implementation are possible. For example, a Microsoft Windows based form of implementation might be provided as illustrated in FIG. 14 to FIG. 16 with FIG. 14 illustrating one form of module interview access screen, FIG. 15 illustrating one form of Channel information entry screen and FIG. 16 illustrating one form of Administration Access.

A functional specification for implementation of one actual prototype implementation will now be described. The terminology utilised in the prototype specification, hereinafter called the “Pathfinder Product Specification” differs in some respects from that used previously. Notably the term “measure” that describes the individual information elements specified during an interview is replaced by the term “BI Element” in the Product Specification. The term “measure” as used in the Product Specification has a more general meaning associated with data sources.

This material provides a functional specification for the implementation of Pathfinder (PF) software currently prototyped as a web application. PF is a tool to assist Business Intelligence Systems (BIS) practitioners specify a new BIS system, or review an existing BIS system and recommend appropriate improvements.

For brevity, the specification is in dot-point form and uses the functionality of the current prototype as a base.

BI Pathfinder supports the efficient specification of BIS system applications. It greatly improves communication between system users, particularly managers and professionals, and the designers regarding the required business intelligence (BI).

The information requirements specification procedure is divided into four modules. Each module has three “channels” that focus on a specific set of business processes and the performance indicators (PIs) needed to support them.

Cumulatively the four modules and their channels build the complete system specification as regards to coverage business areas and aspects to be monitored. Objectives for PF

1. The main objective is to facilitate the specification of KPIs for managing business activity ranging in scale from enterprise-wide to individual business unit, and ranging in direction from pursuit of a new strategy to conduct of normal operations. The emphasis is on specifying what business information (BI) is required to identify and potentially diagnose causes of a problem, and not what is required to rectify the problem.

2. Facilitate review of existing BIS systems with regard to their support of original and current objectives.

3. Enable any competent BIS consultant unfamiliar with an industry to work effectively in helping to specify BIS systems within that industry.

Note that physical design of a BIS system will require additional information not collected by PF. The objective is that PF should enable sufficient detail to be collected to give rough estimates for implementation costs so that implementation of PIs can be divided into stages. Likewise PF does not assist with the specification of a possible data staging component for the BIS system other than to identify potential data sources, nor to what extent the BIS should be implemented with conventional relational tables or with multi-dimensional data cubes.

Pathfinder System/Environment

1. The primary target platform is a Windows PC providing standalone operation.

2. A secondary target environment is to support web-access to PF similar to the prototype.

3. Export to Excel or CSV or alternatively give direct access to DB so as to manipulate/present captured data outside PF system. This reduces the number of required PF reports.

4. Export/import captured data so as to be able to merge results of interviews by separate consultants using standalone PCs. A web platform is to be able to import/export to/from a PC platform, if the web platform is implemented

5. Create a new project from an existing project with the option of also copying (interview results; interviewee data; project data where project name defaults to originating project name prefixed by “Copy of”).

Elements also provide direct links to the corresponding module/channel screens. Channel screens contain links to the individual business process data entry screens, plus navigation icons back to the main navigation screen, to previous channel and to next channel

Business process screens contain navigation icons back to the main navigation screen, to parent channel, to previous business process and to next business process

If the main navigation screen (MNS) was reached via a link from an originating module/channel/business-process screen, then an icon on the MNS will link back to this originating screen

Data for an interview can be entered across multiple user sessions. In particular for the “approved adjusted interview” (AAI) (see Appendix—Pathfinder Usage) data, and any PM can initiate an AAI session and AAI sessions can be synchronised.

The more technical data, ie data that might not be captured during an initial interview with user management, should have separate data entry screens. Eg for a PI a separate screen should be provided for the details of measures, dimensions, costs etc.

Unless it can easily be done in Excel, there is a need for PI Stages, component Costs, and possibly Values to be able to be easily adjusted to provide a credible and consistent whole. In other words, there is a need for one or more “expert planner” data entry screens

Security

The user security levels includeSystem Administrator. There is one System Administrator per project: defines to the system, Users, their passwords and system access level. Access levels will be defined using the concept of Workgroups which are defined by the System Administrator The system will always have a user with login=sysadmin and System Administrator profile. Sysadmin is non-deletable and non-editable. Sysadmin may define other users with System Administrator profile however sysadmin may delete these users or alter their profiles.

Project Managers: There can be multiple Project Managers per project. Project Manager: Creates projects, Deletes projects, Defines to the system:

Projects and project parameters: Which users can access the administered projects. The PM can define other users to have PM rights for individual projects the PM created

Project User: can enter data into a project, if authorised by the Project Manager; can not delete a project.

PathFinder Data

1. System

1.1. User

1.2. User name

1.3. User password

2. Project

2.1. Project Name

2.2. Company Name

2.3. Review or new BIS specification

2.4. If review then original objectives of the BIS system

2.5. Project Instance (PI) status (master, non-master)

2.6. Date-stamp for Project Instance status

2.7. Prefix for generating default PIs in {Module-2, channel-1} from {Module-1}, channel-1

2.8. Suffix for generating default PIs in {Module-2, channel-1} from {Module-1, channel-1}

3. System User

3.1. Project

3.2. UserID

3.3. UserName

3.4. User profile

4. Interviewee

4.1. PersonID

4.2. Name

4.3. Position

4.4. Department

4.5. Division

4.6. Company

5. Interview

5.1. Interviewer—list (allow multiple interviewers)

5.2. Interviewee—list (allow multiple interviewees)

5.3. Interview type—standard; draft assessment; final assessment; post-implementation review. Note that there may be multiple interviews of types <standard> and <draft assessment>

5.4. Date

5.5. Location

6. Performance Indicator (for each P1)

6.1. Business Process Area [BPA]

6.2. Value to interviewee e.g. High Value (4), Important (3), Significant (2), Useful (1).

6.3. Adequacy of current implementation e.g. Good (4), Satisfactory (3), Poor (2), Unavailable (1).

6.4. Frequency

6.5. Security required for PI e.g. Executive, Business Area, Unrestricted

6.6. Dimensions, dimension levels—checked from global dimensions and a single selected set from the potential multiple sets of levels

6.7. Whether the PI will be subject to ad hoc analysis over and above the normal production report filtering and drill-down on levels within each dimension.

6.8. Interview ID

6.9. For each PI that is new or has been edited:

6.9.1. the previous text of PI

6.9.2. new text

6.9.3. interview changed

6.9.4. author/proposer

6.10. Data sources for this PI and set of dimension levels (source is text)

6.11. Availability options for this PI and set of dimension levels: readily available, available with effort, difficult to obtain, and impossible. (The default assumption is that all higher levels can be easily derived from the lowest levels available in the set). This is the effort/cost implementation rating for this PI.

6.12. Required time history to be kept online (months)

6.13. Required retrievable history to be kept in archive (years)

6.14. Comment on quality, timeliness, completeness etc

6.15. Current effort to produce this PI ($/year)

6.16. Current effort Rating to produce this PI (High, Medium, Low), ie< current production cost rating>

6.17. Notional effort to implement ($)

6.18. Notional value to business of having this PI ($)

6.19. BIS implementation-stage for providing this PI.

6.20. Data growth (text description of transactions per month of relevant transactions)

6.21. Defaults for PIs

6.21.1. Any selections of PIs from the first channel in Module 1 will be carried over to the first channel in the Module 2 which deals with benchmarks for those PIs. The default values for the generated PIs are derived from the originating PIs by adding a project-specific prefix and project-specific suffix which are defined during project configuration

6.21.2. Edits to an existing PI or creation of a PI in the first channel in Module 1 will be carried across to the first channel in Module 2

6.21.3. Default interview results for a <draft assessment> type interview are copied from <aggregate> results report or optionally from a previous <draft assessment> type interview in the same project

6.21.4. Default interview results for a <final assessment> type interview are copied from <draft assessment > type interview

7. Dimensions and Levels

7.1. Dimensions: Dimensions are global for a project and there will be relatively few per industry, ie ˜8-10. There may be multiple (not many) hierarchies of levels for the same dimension. For example, products might be classified according to one hierarchy of levels for a Production Department, and to a different hierarchy of levels and categories for Sales and Marketing, with product being the lowest level within each hierarchy. A different example might be the time dimension where one set of levels might be (year, quarter, month, day) and another set is (4-week period, fortnight, and day). BIS software often contains a Dimension Manager to manage this.

7.2. For each dimension

7.2.1. Text field for comment

7.2.2. Name of dimension

7.3. For each set of levels

The multiple sets of levels are the multiple level rollup hierarchies within a dimension. A set of levels is a rollup hierarchy within a dimension. A dimension may have multiple rollup hierarchies.

7.3.1. Name of set (defaulting to name of dimension, duplicates are avoided if necessary by a suffix of the current set count)

7.3.2. List of name of each level in the set ordered from the highest level through to the lowest. It is assumed that the BIS will support drill-down through the levels of a specified set, and not through the union of all levels across all the sets of a dimension.

7.4. For each relevant data source for this dimension, effort to extract data for BIS implementation (Low, Medium, High, Very_High corresponding to data items being readily_available, available_with_effort, difficult_to_obtain, and impossible. This is the implementation cost rating

7.5. For each relevant data source for this dimension, Nominal Implementation Cost to extract data for BIS implementation ($)

8. BIS Security required for each PI

8.1. For simplicity use global security groups across all PIs within a project

8.2. The template global security group values are: Executive, Business Area, Unrestricted 8.3. Values are user definable and editable by Project Managers

9. BIS System Environment

9.1. Availability required for the system

9.2. Level of security required for the system

9.3. Geographic spread of BIS users

9.4. Number of BIS normal users

9.5. Number of BIS power users

9.6. Controls on copying/licencing

10. Data Source

10.1. Name

10.2. Comment

10.3. Effort to extract data for BIS implementation (Low, Medium, High, Very_High corresponding to data items being readily_available, available_with_effort, difficult_to_obtain, and impossible.

10.4. Nominal Implementation Cost to extract data for BIS implementation ($)

11. Data Measure

1.1. Name

11.2. Comment

11.3. Effort to extract data for BIS implementation (Low, Medium, High, Very_High corresponding to data items being readily_available, available_with_effort, difficult_to_obtain, and impossible.

11.4. Nominal Implementation Cost to extract data for BIS implementation ($) Pathfinder Templates

1. The database structure for collecting data during a PF is called a template. That is, a template defines the data fields, their headings, and default project parameters. Different templates can be developed for different industries.

2. The PF system is delivered with one or more non-deletable, non-editable system templates.

3. The sysadmin user can create normal templates by copying a system template.

4. The sysadmin user can edit and delete normal templates

5. A Project Manager can create a project template by copying a normal template. A Project Manager can edit and delete a project template

6. The sysadmin user can create normal templates by copying a project template that may have been edited subsequent to its initial creation from an originating template.

Pathfinder Cost Model for BIS Implementation

Part of the BIS specification is the determination of BIS implementation stages. This is most credibly done if staging can be linked to implementation costs and benefits arising from various staging alternatives. Note that any benefits and costs information is unlikely to be accurate, so that the implementation cost estimate should be considered as notional only.

The PF model used for estimating BIS implementation costs assumes:

1. Implementation cost for the BIS is the summed implementation costs of the PIs in the BIS specification

2. BIS Implementation Cost for a PI is a function of data extraction from one or more originating data sources. This is catered for by allowing cost components defined by user experience. Cost contributions from first-occurrence component are additive

2.1. For first use of data source. User entered cost contribution and availability/cost rating for the data source

2.2. For first use of a measure within a data source. User entered cost contribution for the measure. Multiple measures may be involved for a single PI

2.3. For first use of dimension within a data source. User entered cost contribution for the dimension. Multiple dimensions may be involved for a single PI

2.4. For the construction and display of the PI. User entered cost contribution for the PI

2.5. Cost contributions from first-occurrence elements in a PI are summed

2.6. Subsequent uses of these elements (in subsequent PIs) are assumed to contribute insignificant additional cost to the BIS implementation

3. BIS Implementation Cost Rating for a PI is a function of data extraction from one or more originating data sources. It can be directly assigned from experience by data entry or derived as follows. Allow cost component ratings defined by user experience

3.1. For first use of data source. User entered cost availability/cost rating for the data source

3.2. For first use of a measure within a data source. User entered availability/cost rating for the measure. Multiple measures may be involved for a single PI

3.3. For first use of dimension within a data source. User entered availability/cost rating for the dimension. Multiple dimensions may be involved for a single PI

3.4. For the construction and display of the PI. User entered calculation/presentation/cost rating for the PI

3.5. The maximum of the ratings from first-occurrence elements in a PI is assigned as the BIS implementation cost rating for the PI

3.6. Subsequent uses of these elements (in subsequent PIs) are assumed to contribute insignificant additional cost to the BIS implementation and are ignored in deriving the BIS implementation cost rating for the subsequent PI

4. BIS implementation may or may not require the construction of a data warehouse or a data staging area. However this question only affects the costs and rating values used in the model and is not explicitly considered.

5. BIS operational costs are effectively ignored, or their net present value may be assumed to be incorporated into and distributed across the implementation cost elements

6. The PF user can choose to use all, a combination, or none of the cost contributions by setting values for the cost parameters and/or cost ratings.

6.1. In effect the user can simplify the cost estimatation calculation by choosing zero values for some of the cost values

6.2. Ratings may be easier to assign but they are more problematic to combine so as to get an indication of staging the BIS implementation

6.3. A cost parameter can be validly set to zero. However PF user leaves a cost parameter undefined or assigns a negative value, then the implementaion cost estimate for the PI is also undefined. Likewise if an element used in a PI is undefined then the implementation cost rating is also undefined.

Pathfinder Reports

A user belonging to this project workgroup can generate any report.

All reports should show:

Project name

Company

Date report created prominently on first page

Footer with page number; date report created

PR 1: Single Interview Data Dump:

Purpose: to provide an electronic or hardcopy record of interview for validation by the interviewee should this be desirable

Specification: For a user-specified interviewee:

First section: report title etc

Second section: interview details

Third section: report PI, Value, Adequacy etc. (i.e. all data items) listed in Module/Channel sequence within BPA.

PR 2: Aggregated report for several specified interviewees and dates:

Purpose:

to provide an electronic or hardcopy summary record of a selection of interviews for analysis by the project team to determine stated requirements of the selected group of users.

When the selection covers all relevant interviews, to provide a summary of requirements for discussion and validation by a project steering committee.

Specification:

First section: report title etc

Second section: List Interviewees

Second section: content as PR1, but aggregated showing count of times a particular question is checked (ignore unchecked PIs), average value, average adequacy, highest frequency, average implementation stage, security range, plus listing of dimension/level (s) included (regardless of number of times nominated), collate comments.

PR 3: Manually adjusted aggregated report—

Purpose: for the PM to record the BIS requirements, costs and benefits agreed by the steering committee after discussion of PR2.

Specification:

First section: report title etc

Second section: interview type

Third section: The Report format is as for PR1 excepting for the report title. PR3 is run against interviews types <draft assessment> and <final assessment>, but data entries are agreed values (and not averages) that represent aggregated requirements. Report title should be <Project Name+Draft Final Requirements> or <Project Name+Final Requirements> according to interview type. In other words, PR3 is equivalent to PR1 and only differs in the data it is executed against. PR3 for interview type <final assessment> will be the basis for designing the BI system.

PR 4: BI BPA Value Reports:

Purpose: Summarise by BPAs how well existing BIS facilities are meeting current BI requirements for a selected interview. Usually the selected interview will be a <draft assessment interview> or a <final assessment interview> created by the PM for discussion with the steering committee.

Specification:

First section: report title etc

Second section: interview type

Third section: For specified interview, specified Modules (individual or all), for specified Stages (individual or all):

PR4A1: Title =<BI Value-Adequacy Summary Overall> Count PIs grouped by Value in descending order, and then grouped by Adequacy in descending order. Note that Value level is (High Value, Important. etc), and Adequacy (Low; Medium; High). Format as a matrix of numbers with each column corresponding to a Value and each row to an Adequacy, the cells contain the corresponding counts, finally appending a totals-row and a totals-column.

PR4A2: Title =<BI Value-Adequacy Summary by BPA>

Count PIs firstly grouped by BPA (BPA in data entry order), then grouped by Value in descending order, and finally grouped by Adequacy in descending order. Note that Value level is (High Value; Important . . . etc), and Adequacy (Low; Medium; High). For each BPA, format as a matrix of numbers with each column corresponding to a Value and each row to an Adequacy, finally appending a totals-row and a totals-column.

PR 4B1: Title =<BI Value-Adequacy Listing>

List PIs grouped by Adequacy in descending order, and then grouped by Value in descending order. Output Value Rating, Adequacy, Current Production Cost Rating, Availability

PR 4B2: Title =<BI Value-Adequacy Listing by BPA>

List PIs firstly grouped by BPA (BPA in data entry order), then grouped by Adequacy in descending order, and finally grouped by Value in descending order. Output Value Rating, Adequacy, Current Production Cost Rating, Availability

PR 4C1: Title =<BI Adequacy-Value Listing>

List PIs grouped by Value in descending order, and then grouped by Adequacy in descending order. Output Value Rating, Adequacy, Current Production Cost Rating, Availability

PR 4C2: Title =<BI Adequacy-Value Listing by BPA>

List PIs firstly grouped by BPA (BPA in data entry order), then grouped by Value in descending order, and finally grouped by Adequacy in descending order. Output Value Rating, Adequacy, Current Production Cost Rating, Availability

PR 5: BI Cross-BPA Value Reports:

Purpose: Summarise across BPAs how well existing BIS facilities are meeting current BI requirements for a selected interview. Usually the selected interview will be a <draft assessment interview> or a <final assessment interview>.

Specification:

First section: report title etc

Second section: interview type

Third section: For each Value level (eg: High Value; Important. etc), Count number of low, medium and high adequacy PIs.

PR5A: List PIs firstly grouped by Adequacy in descending order, then within Adequacy grouped by Value in descending order, and finally grouped by BPA (BPA in data entry order). Output Value Rating, Adequacy, Current Production Cost Rating, Availability

PR5B: List PIs firstly grouped by Value in descending order, then within Value grouped by Adequacy in descending order, and finally grouped by BPA (BPA in data entry order). Output Value Rating, Adequacy, Current Production Cost Rating, Availability

PR 6: Dimension Report:

Purpose: Indicate the importance of individual dimensions in reporting BI.

Specification:

For each dimension count the total number of PIs requested and then a breakdown of the count for each value/adequacy combination.

PR 7: Dimension Combination Report:

Purpose: To give some guidance for BI implementation (multi-dimensional cubes, dimensional models etc) for a selected interview. Usually the selected interview will be a <draft assessment interview> or a <final assessment interview>.

Specification:

List all Dimension combinations, starting with each single dimension, then each pair, then triples, etc.: reporting count of PIs, average value, average adequacy.

PR 8: Ad hoc Dimension report:

Purpose: To give some guidance for BI implementation (multi-dimensional cubes, dimensional models etc) for a selected interview. Usually the selected interview will be a <draft assessment interview> or a <final assessment interview>.

Specification:

Key in one or a combination of Dimensions. Pathfinder responds with a count of the number of instances, average value and adequacy. Lists each PI, with associated BPA, value, adequacy, etc. for that combination or a subset of that combination.

PR 9: Other PF Reports

PR9A: Kimball's Bus-Matrix

Purpose: Indicate overall current requirements in terms of a summary of BI-measures and corresponding dimensions for a selected interview. Usually the selected interview will be a <draft assessment interview> or a <final assessment interview>.

Specification:

First section: report title etc

Second section: interview type

PR9A1: Third section: Title =<BI Bus-Matrix Measures> For specified interview, specified Modules (individual or all), for specified Stages (individual or all); rows are PF-business measures; columns are PF-dimensions; matrix elements/cells are blank or “1”if this row-column combination is a requirement

PR9A2: Third section: Title=<BI Bus-Matrix Indicators> For specified interview, specified Modules (individual or all), for specified Stages (individual or all); rows are PIs; columns are PF-dimensions; matrix elements/cells are blank or “I” if this row-column combination is a requirement

PR9B: Kimball's Opportunity-Matrix

Purpose: Indicate which business organisational groups or functions will be involved during a BIS implementation of the requirements specified for a selected interview. Usually the selected interview will be a <draft assessment interview> or a <final assessment interview>.

Specification:

First section: report title etc

Second section: interview type

PR9BI: Third section: Title =<BI Opportunity-Matrix Measures> For specified interview, specified Modules (individual or all), for specified Stages (individual or all—if all then order Stage-1 to last Stage); rows are PF-business measures; columns are business organisational groups or functions; matrix elements/cells are blank or “1” if this row-column combination is a requirement

PR9B2: Third section: Title =<BI Opportunity-Matrix Indicators> For specified interview, specified Modules (individual or all), for specified Stages (individual or all—if all then order Stage-1 to last Stage); rows are PIs; columns are business organisational groups or functions; matrix elements/cells are blank or “1” if this row-column combination is a requirement

PR10: PF PI Value-Adequacy Report

Purpose: Assist with specifying the scope and stages of the BIS for a selected interview assuming that current PI adequacy has no significant effect on the outcome. Also assume that dollar benefits and costs have been assigned to PI elements. Usually the selected interview will be a <draft assessment interview> or a <final assessment interview>. The sort order assists a staging strategy emphasising first implementing the highest value PIs and where there is a cut-off at a value then ensuring that where possible the PIs least adequately provided are also selected.

Specification:

First section: report title etc

Second section: interview type

Third section: Title =<BI PI Value-Adequacy > For specified interview, specified Modules (individual or all), for specified Stages (individual or all—if all then order Stage-1 to last Stage);

List PIs in descending order of Value. Within Value order in ascending current Adequacy; assign a cost to the PI as specified by the PI cost model. For each PI output Value, Implementation Cost, accumulated PI value, accumulated implementation cost, current adequacy, current production cost

PR11: PF PI Adequacy-Value Report

Purpose: Assist with specifying the scope and stages of the BIS for a selected interview assuming that current PI adequacy has a significant effect on the outcome. Also assume that dollar benefits and costs have been assigned to PI elements. Usually the selected interview will be a <draft assessment interview> or a <final assessment interview>. The sort order assists a staging strategy emphasising first implementing the least adequately provided PIs and where there is a cut-off at a value then ensuring that where possible the highest value PIs are also selected.

Specification:

First section: report title etc

Second section: interview type

Third section: Title =<BI PI Adequacy-Value > For specified interview, specified Modules (individual or all), for specified Stages (individual or all—if all then order Stage-1 to last Stage);

List PIs in ascending order of current adequacy (least adequate to most). Within adequacy order in descending order of Value. Assign a cost to the PI as specified by the PI cost model. For each PI output Value, Implementation Cost, accumulated PI value, accumulated implementation cost, current adequacy, current production cost

PR12: PF PI Adequacy Current-Cost Report

Purpose: Assist with specifying the scope and stages of the BIS for a selected interview assuming that current PI Adequacy and the cost of currently providing the PI has a significant effect on the outcome. Also assume that dollar benefits and costs have been assigned to PI elements. Usually the selected interview will be a <draft assessment interview> or a <final assessment interview>. The sort order assists a staging strategy emphasising first implementing the least adequately provided PIs and where there is a cut-off at a value then ensuring that where possible the PIs with the highest <current cost to produce> are also selected.

Specification:

First section: report title etc

Second section: interview type

Third section: Title =<BI PI Adequacy Current-Cost > For specified interview, specified Modules (individual or all), for specified Stages (individual or all—if all then order Stage-1 to last Stage); List PIs in ascending order of current Adequacy (least to most) and within Adequacy order in descending order of <current cost to produce>. Assign an implementation cost to the PI as specified by the PI cost model. For each PI output Value, Implementation Cost, accumulated PI value, accumulated implementation cost, current adequacy, current production cost

PR13: PF PI Value-Adequacy Rating Report

Purpose: Assist with specifying the scope and stages of the BIS for a selected interview assuming that current PI Adequacy has no significant effect on the outcome. Also assume that benefit and cost ratings have been assigned to PIs, ie no dollar parameters are required. Usually the selected interview will be a <draft assessment interview> or a <final assessment interview>. The sort order assists a staging strategy emphasising first implementing the highest value PIs and where there is a cut-off at a value then ensuring that where possible the PIs least adequately provided are also selected.

Specification:

First section: report title etc

Second section: interview type

Third section: Title =<BI PI Value-Adequacy Rating > For specified interview, specified Modules (individual or all), for specified Stages (individual or all—if all then order Stage-1 to last Stage);

List PIs in descending order of Value Rating. Within Value Rating order in ascending current Adequacy. For each PI output PI Value Rating, current adequacy, current production cost rating, PI Implementation Cost Rating, accumulated counts of PI value rating, accumulated counts of PI implementation cost rating

PR14: PF PI Adequacy-Value Rating Report

Purpose: Assist with specifying the scope and stages of the BIS for a selected interview assuming that current PI adequacy has a significant effect on the outcome. Also assume that benefit and cost ratings have been assigned to PIs, ie no dollar parameters are required. Usually the selected interview will be a <draft assessment interview> or a <final assessment interview>. The sort order assists a staging strategy emphasising first implementing the least adequately provided PIs and where there is a cut-off at a value then ensuring that where possible the highest value PIs are also selected.

Specification:

First section: report title etc

Second section: interview type

Third section: Title =<BI PI Cost Benefit > For specified interview, specified Modules (individual or all), for specified Stages (individual or all—if all then order Stage-1 to last Stage);

List PIs in ascending order of current adequacy (least adequate to most). Within adequacy order in descending order of Value Rating. For each PI output PI Value Rating, current adequacy, current production cost rating, PI Implementation Cost Rating, accumulated counts of PI value rating, accumulated counts of PI implementation cost rating

PR15: PF PI Adequacy Current-Cost Rating Report

Purpose: Assist with specifying the scope and stages of the BIS for a selected interview assuming that current PI Adequacy and the cost of currently providing the PI has a significant effect on the outcome. Also assume that benefit and cost ratings have been assigned to PIs, ie no dollar parameters are required. Usually the selected interview will be a <draft assessment interview> or a <final assessment interview>. The sort order assists a staging strategy emphasising first implementing the least adequately provided PIs and where there is a cut-off at a value then ensuring that where possible the PIs with the highest <current cost to produce> are also selected.

Specification:

First section: report title etc

Second section: interview type

Third section: Title =<BI PI Adequacy Current-Cost Rating > For specified interview, specified Modules (individual or all), for specified Stages (individual or all—if all then order Stage-1 to last Stage);

List PIs in ascending order of current Adequacy (least to most) and within Adequacy order in descending order of <current production cost rating>. For each PI output PI Value Rating, current adequacy, current production cost rating, PI Implementation Cost Rating, accumulated counts of PI value rating, accumulated counts of PI Implementation Cost Rating

PR16: PF PI Data Source Matrix

Purpose: Indicate overall current requirements in terms of a summary of BI PIs and corresponding data-sources for a selected interview. Usually the selected interview will be a <draft assessment interview> or a <final assessment interview>. Report gives an indication of the degree to which a data source is accessed.

Specification:

First section: report title etc

Second section: interview type

PR9A1: Third section: Title =<BI Data Source Matrix > For specified interview, specified Modules (individual or all), for specified Stages (individual or all); rows are PF-PIs; columns are Data Sources; matrix elements/cells are blank or “1” if this row-column combination is a requirement.

PR17: PF Data Source Value Report

Purpose: Assist with specifying the scope and stages of the BIS for a selected interview assuming that current PI Adequacy has no significant effect on the outcome. Also assume that benefit and cost ratings have been assigned to PIs, ie no dollar parameters are required. Usually the selected interview will be a <draft assessment interview> or a <final assessment interview>. The data source order assists a staging strategy emphasising first implementing the highest value data sources as implied by the PIs they support.

Specification:

First section: report title etc

Second section: interview type

Third section: Title =<BI Data Source Value Report>.

For specified interview, specified Modules (individual or all), for specified Stages (individual or all—if all then order Stage-1 to last Stage);

Within Data Source ordering (defined below), list PIs in descending order of Value. Within Value order in ascending current Adequacy. For each PI output PI Value, current adequacy, current PI Production Cost, PI Implementation Cost, accumulated PI value, accumulated PI Implementation Cost, accumulated current PI Production Cost.

Data Source Ordering. (The algorithm is not optimal but is reasonable and is easily explained)

Step 0: Put the initial set of implemented Data Sources (DS) as empty and the initial set of implemented PIs as empty.

Step 1: Stop if there are no non-implemented DSs or if there are no non-implemented PIs

Step 2: Put the number (NAdd) of DSs to be added to the already implemented set=1, ie NAdd=1

Step 3: For each combination of NAdd DS in the non-implemented DS, sum the value of the non-implemented PIs that could now be implemented with that combination of DSs and the currently implemented set of DSs.

Step 4: If there are no new PIs that could be implemented, increment NAdd by 1 and repeat step 3. The loop must terminate since if the data is complete then all PIs are implementable with all DSs

Step 5: Put those new PIs with the highest summed value and the corresponding combination of DSs into the implemented sets.

Step 6: Repeat Step 2

PF Graphical Output

3-D Histogram of PIs with X-Axis being value of PI, Y-Axis being current adequacy, Z-Axis being count of PIs for this (x,y). Use aggregated PI characteristics with ratings rounded to first decimal.

(Note: This information is identical to report PR4A1)

3-D Histogram of PIs with X-Axis being value of PI, Y-Axis being effort to implement, Z-Axis being count of PIs for this (x,y). Use aggregated PI characteristics with ratings rounded to first decimal

3-D Histogram of PIs with X-Axis being value of PI, Y-Axis being number of organisational business units interested in PI, Z-Axis being count of PIs for this (x,y). Use aggregated PI characteristics with ratings rounded to first decimal

3-D Histogram of PIs with X-Axis being value of PI, Y-Axis being current adequacy, Z-Axis being sum of PIs for this (x,y). Use aggregated PI characteristics with ratings rounded to first decimal

The histograms should be able to be selected by PI implementation stages and for all PIs, and likewise consider for individual interviews, the most common interview being aggregated and the “final assessment”

### Pathfinder Usage

Roles in Using the Pathfinder Tool: The System Administrator (SA) role can create and maintain Pathfinder (PF) templates and users. The SA assign Project Managers. The Project Manager (PM) role can create and setup one or more projects by copying a template and then subsequently editing the copied configuration. The PM can assign users to a project. The PM can have the rights of a Project User but can also finalise the BIS requirements ie can set interview status equal to “finalisation of requirements” and enter data A Project User role can record the data gathered during interviews into PF. The role can also be able to edit and insert PIs dimensions and dimension levels.

Pathfinder Glossary

| Item | PF Definition |
|---|---|
| BIS User | User of the project target BIS system |
| Dimension | Non-numeric data used for grouping and filtering |
| | Indicators for display to a BIS user. |
| | Example 1: Sales Location |
| | Example 2: Sex |
| | Example 3: Product |
| KPI | Key PI, ie one of the most important PIs |
| PF Project | PF user who manages a PF project |
| Manager | |
| PF System | PF user who manages a PF software system |
| Administrator | |
| PF User | User of the PF software |
| PF-Business | A basic or derived numeric data variable that is not a |
| Indicator | dimension and is displayed by the BIS. Also referred |
| | to as an Indicator. An Indicator is a function of one or |
| | more Measures, and requires data extracted from one or |
| | more data sources. |
| | Example 1: Revenue per unit showroom area ($/sq.m) |
| | at a Sales Location |
| | Example 2: Average age of male employees |
| PF-Business | A numeric data variable directly available from an |
| Measure | originating data source. Also referred to as a Measure. |
| | If BIS requirements are that a measure is seen by a PF |
| | user, it is also an Indicator |
| | Example 1: Revenue ($) |
| | Example 2: Age |
| | Example 3: Showroom area (sq.m) |
| PI | Performance Indicator. Same as a PF-Business |
| | Indicator |
| Data Source | Assumed originating source of data for a subset of |
| | measures and dimensions. The BIS system |
| | implementation will involve multiple data sources. The |
| | PF model for implementation effort is that effort will |
| | have a significant component attributable to a data |
| | source and additive components for each dimension |
| | and measure from that source. Consequently a PF |
| | construction of implementation effort requires dealing |
| | with the concept of Data Sources. It is possible for |
| | multiple measures to be available from the one data |
| | source. |

The foregoing describes one form of the preferred embodiment. Modifications, obvious to those skilled in the art can be made thereto without departing from the scope of the invention.

1. An executive information requirements specification system for utilisation in conjunction with the Business Intelligence operations of an organisation, said system including:
at least one of four interactive modules that control the desirable path for interviewing an executive to determine a BI system specification, each of said modules storing information relevant to a project or an organisation, the modules including:
(a) a first module eliciting and storing information requirements related to the operational status of the organisation;
(b) a second module eliciting and storing information requirements about the relevant acceptability of the operational status of the organisation;
(c) a third module eliciting and storing information requirements derived from forecasting and exception analysis models of the organisation; and
(d) a fourth module eliciting and storing information and model requirements likely to be required should a problem be identified with the organisation.

2. A system as claimed in claim 1 wherein each of said modules includes a number of sub-modules eliciting and storing information relevant to the module for interaction with or by a user including information quantifying the value of specified requirements to the executive and the adequacy of current implementations of the requirements in a BI system (if any).

3. A system as claimed in claim 2 wherein said first module includes a series of submodules directed to at least one of the project or organisation key performance indicators and customer feedback.

4. A system as claimed in claim 2 wherein said second module includes a series of submodules directed to at least one of many possible benchmarks that the organisation has sought to achieve, relative performance measurements, exceptional situations and market feedback.

5. A system as claimed in claim 2 wherein said third module includes a series of submodules directed to significant changes in at least one of trends established in operational key time series, forecasting model results, and verbal reports of unexpected events in the marketplace.

6. A system as claimed in claim 2 wherein said fourth module includes a series of submodules directed to at least one of tools allowing for fast diagnosis of problems and to ensuring data availability for answering anticipated questions.

7. A system as claimed in claim 1 wherein said system is implemented via an internet browser environment or via one, or a network of, personal computers

8. A method of eliciting and specifying executive information requirements in a useable form, the method comprising the step of providing an interactive computer based system including a series of interactive modules, the modules including:
(a) a first module eliciting and storing information requirements related to the operational status of an organisation;
(b) a second module eliciting and storing information requirements about the relevant acceptability of the operational status of the organisation;
(c) a third module eliciting and storing information requirements derived from forecasting and exception analysis models of the organisation; and
(d) a fourth module eliciting and storing information and model requirements likely to be required should a problem be identified with the organisation.

9. A method as claimed in claim 8 further comprising the reporting the results of interviews utilising at least one of the modules, the reports including at least one of:
a) information obtained in an interview highlighting the important measures required from a BI system by the interviewee;
b) a set of aggregated information resulting from two or more interviews utilising at least one of the four modules, providing averages and other indications of the range of measures selected, the value of measures and the adequacy of current implementations;
c) measures of significance to a user and the adequacy of current implementations, thereby assisting the process of auditing the quality of existing BI systems d) graphical displays of the relationships between various measures elicited from the models.
